(19) United States
(12) Patent Application Publication
(10) Pub. No.: US 2021/0092203 A1
(43) Pub. Date: Mar. 25, 2021

(54) CLIENT, SERVER, AND CLIENT-SERVER SYSTEM ADAPTED FOR UPDATING A CLIENT-ITEM MATRIX

(71) Applicant: HUAWEI TECHNOLOGIES CO., LTD., Shenzhen (CN)

(72) Inventor: Adrian FLANAGAN, Helsinki (FI)

(21) Appl. No.: 16/954,300

(22) PCT Filed: Dec. 22, 2017
(86) PCT No.: PCT/EP2017/084494

§ 371 Date: Jun. 16, 2020

(51) Int. Cl. H04L 29/06; H04L 12/24

(52) U.S. Cl. CPC H04L 67/42; H04L 41/0803

(57) ABSTRACT

A client machine is configured for an efficient machine learning process that has access to the client data of all clients connected to a server. The machine learning process is also secure because the client data related to each individual client remains on the same client. Since the server connected to the client does not collect or store large amounts of client data, the machine learning process is time efficient and cost effective.

### CROSS-REFERENCE TO RELATED APPLICATIONS

This application is a US National Stage of International Patent Application No. PCT/EP2017/084494, filed on Dec. 22, 2017, which is hereby incorporated by reference in its entirety.

### TECHNICAL FIELD

The disclosure relates to an improved client, server, and client-server system allowing individual elements of a client-item matrix to be updated.

### BACKGROUND

A client-server system is a structure in which the tasks of the system is divided between the provider of a service, i.e. a server, and service requesters, i.e. clients. The server may run one or more programs which share their resources with the clients. The client, on the other hand, does not share any of its resources, but requests a server's content or service function. The clients, i.e. user devices such as mobile phones or tablets, are an important part of a machine learning process used in such a client-server system, since each client is a source of data, the data being used for building the models used in the machine learning process and for generating the results from the models.

The results may, e.g., be used to generate a recommendation of one or several specific items, taken from a larger set of items, which may be of interest to the user of the client. An item is, e.g., a video available for viewing, an application available for downloading, or a physical object such as a piece of clothing available for purchase. The clients and the items may be collected in a so-called client-item matrix.

The machine learning process comprises creating complex models and algorithms which may be used for calculating estimates of any unspecified elements, i.e. missing values, of the client-item matrix, e.g. by exploiting patterns found in historical and transactional data. The estimates of the missing values indicate the probability of the user viewing the above-mentioned video, downloading the application, or purchasing the piece of clothing.

It is difficult to achieve an efficient machine learning process, since it is hard to find patterns and oftentimes there is not sufficient training data available; as a result, machine learning processes often fail to deliver. Hence, it is important that as much data as possible is available to the machine learning process. For a client-server system, this translates to the server having access to as many clients, and their data, as possible. Each client is a user device such as a mobile phone or a tablet, and it is not only a source of data used for building models used in the machine learning process, but it is also the medium for delivering the results of the models, i.e. estimates replacing the above-mentioned unspecified elements.

Clients, such as mobile phones and tablets, comprise different kinds of personal user data, e.g., client location, which may be considered very sensitive personal data, and downloaded applications, which may be considered not particularly sensitive personal data. Regardless of the sensitivity levels, the data is still considered to be personal user data.

Regulations such as, e.g., the GDPR (General Data Protection Regulation) which is to be enforced in the EU countries in 2018, as well as general scrutiny of how companies collect, store, and use user data are issues which make generating estimates more difficult, and maybe even impossible when explicit user opt-in consent is required to collect the user's data and to store and process it. With surveys disclosing opt-in rates as low as 20%, trying to generate such estimates may no longer be useful.

Furthermore, collecting gigabytes of user data daily, for a large number of clients, as well as storing and using the data securely, requires expensive infrastructure and administration solutions.

### SUMMARY

It is an object to provide an improved client, server, and client-server system.

The foregoing and other objects are achieved by the features of the independent claims. Further implementation forms are apparent from the dependent claims, the description, and the figures.

According to a first aspect, there is provided a client adapted for updating individual elements of a client-item matrix by means of collaborative filtering, R=X^{T}Y, rᵢⱼ=xᵢ^{T}yⱼ, T being a matrix/vector transpose, the matrix comprising a plurality of individual elements, each individual element relating to a specific client and a specific item, the client utilizing an individual part of a first model component and at least one element of local client data, the first model component being a factor matrix A=X(i,k) comprising a plurality of client factor vectors,

$${x}_{i} = ( \begin{matrix}{x}_{i 1} \\ {x}_{i 2} \\ ⋮ \\ {x}_{i k}\end{matrix} ) ,$$

k being the number of factors, the individual part of the first model component being the client factor vector for the client, the client being connected to a server utilizing a second model component and a global set of items, M being a maximum number of items, the second model component being a factor matrix B=Y(j,k) comprising a plurality of item factor vectors,

$${y}_{j} = ( \begin{matrix}{y}_{j 1} \\ {y}_{j 2} \\ ⋮ \\ {y}_{j k}\end{matrix} ) ,$$

k being the number of factors, the client being configured to: assign the individual part of the first model component to the client, download a second model component from the server, calculate an updated individual part of the first model component by means of the downloaded second model component and the element of local client data, calculate an individual value for each item by means of a function f(i,j), the function using the downloaded second model component, the updated individual part of the first model component, and the element of local client data, upload an evaluation of the value to the server such that an updated 10 second model component is calculated by the server by means of the second model component and an aggregate of evaluations of the value uploaded from a plurality of clients including the client and other determined clients, N being a maximum number of clients, download the updated second model component from the server, calculate a new updated individual part of the first model component by means of the updated second model component and the element of local client data, update at least one individual element of the matrix by means of the new updated individual part of the first model component and the updated second model component.

A client, comprising these features, allows for a machine learning process which is efficient, since it has access to the client data of all clients connected to a server, as well as secure, since the client data related to an individual client remains on the very same. Since the server, connected to the client, does not have to collect or store large amounts of client data, the process is time- and cost-effective as well.

In a possible implementation form of the first aspect, at least one individual element of the client-item matrix is unspecified, and the updating of individual elements comprises replacing an unspecified individual element with an estimate, \hat{r}ᵢⱼ=xᵢ^{T}yⱼ, allowing an initially sparse client-item matrix to become dense with elements.

In a further possible implementation form of the first aspect, the client-item matrix is used for generating personalized application recommendations for a user of the client, the recommendations, relating to at least one of the items, being generated on the client by means of the individual elements, such that the user of a client can be provided with item recommendations which are relevant to the user.

In a further possible implementation form of the first aspect, the aggregate of evaluations is calculated by means of equation

$$\frac{\partial J}{\partial {y}_{j}} = - 2 {Σ}_{i} f ( i , j ) + 2 λ {y}_{j} ,$$

wherein λ is a regularization parameter and J is a cost function, allowing an aggregate, which correctly reflects the content of the client data of the clients, to be generated, without transferring any client data from the client.

In a further possible implementation form of the first aspect, the second model component is updated by means of equation

$${y}_{j} = {y}_{j} - γ \frac{\partial J}{\partial {y}_{j}} ,$$

wherein γ is a gain function, allowing the second model component to be updated on the server, in response to client data, without having direct access to the client data.

In a further possible implementation form of the first aspect, the function f(i,j) is calculated by means of equation f(i,j)=[pᵢⱼ(rᵢⱼ−xᵢ^{T}yⱼ)]xᵢ, wherein p is a binary preference variable which indicates the preference of a user of a client for an item, by means of

$${p}_{ij} \{ \begin{matrix}1 & {r}_{i j} > 0 \\ 0 & {r}_{i j} = 0\end{matrix} ,$$

a value pᵢⱼ=1 indicating an interest in item, and a value pᵢⱼ=0 indicating one of a disinterest in item or unawareness of the item, allowing the explicit preferences, such as reviews, of the individual user to be taken into account.

In a further possible implementation form of the first aspect, the first model component is updated by means of equation xᵢ=(Yp(i)Y^{T}+λI)⁻¹YRⁱp(i), wherein p(i) is a binary preference variable vector for the client, Rⁱ is a vector of known inputs for client, I is an identity matrix, and λ is a regularization parameter, allowing the first model component to be updated solely on the client.

In a further possible implementation form of the first aspect, the element of local client data comprises implicit user feedback relating to one of the items, allowing estimates to be made on the basis of user actions.

In a further possible implementation form of the first aspect, the function f(i,j) is calculated by means of equation f(i,j)=[cᵢⱼ(pᵢⱼ−xᵢ^{T}yⱼ)]xᵢ, wherein c is a confidence parameter and p is a binary preference variable which indicates the preference of a user of a client for an item, by means of

$${p}_{ij} \{ \begin{matrix}1 & {r}_{i j} > 0 \\ 0 & {r}_{i j} = 0\end{matrix} ,$$

a value pᵢⱼ=1 indicating an interest in item, and a value pᵢⱼ=0 indicating one of a disinterest in item or unawareness of the item, allowing the implicit preferences of the individual user, such as downloads, to be taken into account.

In a further possible implementation form of the first aspect, the first model component is updated by means of equation xᵢ=(YCⁱY^{T}+λI)⁻¹YCⁱp(i), wherein p(i) is a binary preference variable vector for the client, Cⁱ is a diagonal matrix, and λ is a regularization parameter, allowing the first model component to be updated solely on the client.

According to a second aspect, there is provided a server adapted for updating individual elements of a client-item matrix R by means of collaborative filtering, R=X^{T}Y, rᵢⱼ=xᵢ^{T}yⱼ, T being a matrix/vector transpose, the matrix comprising a plurality of individual elements, each individual element relating to a specific client and a specific item, the server utilizing a second model component and a global set of items, M being a maximum number of items, the second model component being a factor matrix B=Y(j,k) comprising a plurality of item factor vectors,

$${y}_{j} = ( \begin{matrix}{y}_{j 1} \\ {y}_{j 2} \\ ⋮ \\ {y}_{j k}\end{matrix} ) ,$$

k being the number of factors, the server being connected to a plurality of clients utilizing a first model component, N being a maximum number of clients, each individual client comprising an individual part of the first model component, and each individual client further utilizing at least one element of local client data, the first model component being a factor matrix A=X(i,k) comprising a plurality of client factor vectors,

$${x}_{i} = ( \begin{matrix}{x}_{i 1} \\ {x}_{i 2} \\ ⋮ \\ {x}_{i k}\end{matrix} ) ,$$

k being the number of factors, the individual part of the first model component being the client factor vector for the client, the server being configured to: determine several of the clients, assign a second model component to the server, receive an aggregate of evaluations of individual values from the several determined clients, wherein in each determined client an updated individual part of the first model component is calculated by means of the assigned second model component which is downloaded by each determined client and the element of local client data, and the individual value for each item is calculated by means of a function f(i,j), the function using the assigned second model component, the updated individual part of the first model component, and the element of local client data, and the evaluation of the value is uploaded by each determined client to the server, calculate an updated second model component by means of the assigned second model component and the aggregate of evaluations uploaded from the several determined clients, transmit the updated second model component to each determined client such that, in each determined client, a new updated individual part of the first model component is calculated by means of the updated second model component and the element of local client data, and at least one individual element of the matrix is updated, on the determined client, by means of the new updated individual part of the first model component and the updated second model component.

A server, comprising these features, allows for a machine learning process which is efficient, since it has access to the client data of all clients connected to the server, as well as secure, since any client data related to an individual client remains on the very same. Since the server does not have to collect or store large amounts of client data, the process is time- and cost-effective as well.

In a possible implementation form of the second aspect, at least one individual element of the client-item matrix is unspecified, and the updating of individual elements, on the determined client, comprises replacing an unspecified individual element with an estimate, \hat{r}ᵢⱼ=xᵢ^{T} yⱼ, allowing an initially sparse client-item matrix to become dense with elements.

In a further possible implementation form of the second aspect, the client-item matrix is used for generating personalized application recommendations for a user of the client, the recommendations, relating to at least one of the items, being generated on the client by means of the individual elements, such that the user of a client can be provided with item recommendations which are relevant to the user.

In a further possible implementation form of the second aspect, the aggregate of evaluations is calculated by means of equation

$$\frac{\partial J}{\partial {y}_{j}} = - 2 {Σ}_{i} f ( i , j ) + 2 λ {y}_{j} ,$$

wherein λ is a regularization parameter and J is a cost function, allowing an aggregate, which correctly reflects the content of the client data of the clients, to be generated, without transferring any client data from the client.

In a further possible implementation form of the second aspect, the second model component is updated by means of equation

$${y}_{j} = {y}_{j} - γ \frac{\partial J}{\partial {y}_{j}} ,$$

wherein γ is a gain function, allowing the second model component to be updated on the server, in response to client data, without having direct access to the client data.

In a further possible implementation form of the second aspect, the function f(i,j) is calculated by means of equation f(i,j)=[pᵢⱼ(rᵢⱼ−xᵢ^{T}yⱼ)]xᵢ, wherein p is a binary preference variable which indicates the preference of a user of a client for an item, by means of

$${p}_{ij} \{ \begin{matrix}1 & {r}_{i j} > 0 \\ 0 & {r}_{i j} = 0\end{matrix} ,$$

a value pᵢⱼ=1 indicating an interest in item, and a value pᵢⱼ=0 indicating one of a disinterest in item or unawareness of the item, allowing the explicit preferences, such as reviews, of the individual user to be taken into account.

In a further possible implementation form of the second aspect, the first model component is updated by means of equation xᵢ=(Yp(i)Y^{T}+λI)⁻¹YRⁱp(i), wherein p(i) is a binary preference variable vector for the client, Rⁱ is a vector of known inputs for client, I is an identity matrix, and λ is a regularization parameter, allowing the first model component to be updated solely on the client.

In a further possible implementation form of the second aspect, the element of local client data comprises implicit user feedback relating to one of the items, allowing estimates to be made on the basis of user actions.

In a further possible implementation form of the second aspect, the function f(i,j) is calculated by means of equation f(i,j)=[cᵢⱼ(pᵢⱼ−xᵢ^{T}yⱼ)]xᵢ, wherein c is a confidence parameter and p is a binary preference variable which indicates the preference of a user of a client for an item, by means of

$${p}_{ij} \{ \begin{matrix}1 & {r}_{i j} > 0 \\ 0 & {r}_{i j} = 0\end{matrix} ,$$

a value pᵢⱼ=1 indicating an interest in item, and a value pᵢⱼ=0 indicating one of a disinterest in item or unawareness of the item, allowing the implicit preferences of the individual user, such as downloads, to be taken into account.

In a further possible implementation form of the second aspect, the first model component is updated by means of equation xᵢ=(YCⁱY^{T}+λI)⁻¹YCⁱp(i), wherein p(i) is a binary preference variable vector for the client, Cⁱ is a diagonal matrix, I is an identity matrix, and λ is a regularization parameter, allowing the first model component to be updated solely on the client.

According to a third aspect, there is provided a client-server system adapted for updating individual elements of a client-item matrix R by means of collaborative filtering, the system comprising multiple clients, described above, and a server, described above. A client-server system, comprising these features, allows for a machine learning process which is efficient, since it has access to the client data of all of the clients, as well as secure, since any client data related to an individual client remains on the very same. Since the server does not have to collect or store large amounts of client data, the process is time- and cost-effective as well.

This and other aspects will be apparent from the embodiments described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 is a schematic drawing of a client-server system according to one embodiment of the present disclosure.

FIG. 2 is a schematic diagram showing steps executed within the system shown in FIG. 1.

### DETAILED DESCRIPTION

As mentioned in the background section, a client-server system is a structure in which the tasks of the system is divided between the provider of a service, i.e. a server, and service requesters, i.e. clients such as mobile phones or tablets. The service to be provided may be a video service, all of the user data associated with the video service being stored on the server.

Prior art model building comprises sending personal user data from a client to a central server where the data is processed, models are built, and results are generated and sent back to the client. The results may, e.g., be an estimate to be used, later on, for generating recommendations of one or several specific items predicted, by one or several models, to be of interest to the user of the client. An item is, e.g., a video available for viewing, an application available for downloading, or a physical object such as a piece of clothing available for purchase.

The number of clients as well as available items is usually very large, and are preferably collected in a client-item matrix R=(rᵢⱼ)∈R^{NxM}, N being the maximum number of clients i connected to the server, and M being the maximum number of items j available on the server.

Given the number of clients N can be several million, and the number of items M several thousand, the client-item matrix R may be sparse with many elements rᵢⱼ unspecified. One object of the present disclosure is to replace such unspecified elements with their estimates \hat{r}ᵢⱼ.

Contrary to prior art, and due to technological advancement such as a general increase in computational ability of clients, the present disclosure generates such estimates while still maintaining all personal user data on the client, i.e. personal user data is neither used nor stored on a central server. Hence, the amount of data to be transferred to, and stored on, the server is reduced, and issues related to data collection and user privacy are avoided.

The above is achieved by means of, i.a., collaborative filtering. In short, in collaborative filtering a model is built from a user's past behavior, such as items previously purchased or selected and/or numerical ratings given to those items by the user, as well as similar decisions made by other users. This model is then used to predict which other items the user may have an interest in. Collaborative filtering is one of the most used models to generate recommendations for a user, either independently or in combination with other types of models such as, e.g., predictive modeling. In prior art, these models both require gathering all data to be used in building the model to be collected in a centralized server.

As previously mentioned, the number of clients as well as the number of items is usually very large, wherefore a combination of models may be used to provide only relevant recommendations to the user of a specific client i. As an example, collaborative filtering may be used to generate a first set of item recommendations, a so-called candidate set comprising some, if not all, of the above-mentioned elements rᵢⱼ and estimates \hat{r}ᵢⱼ, whereafter predictive modeling may be used to create the final, usable recommendations by scoring the initially recommended items and sorting them by weight.

The estimates may be based on implicit and/or explicit feedback from not only the specific client but a plurality of clients, in one embodiment all possible clients. Implicit feedback comprises actions taken by the user, e.g. downloading an application. Explicit feedback comprises user reviews of items. Collaborative filtering only uses these two kinds of data, while the above-mentioned predictive modeling may use additional kinds of explicit feedback such as demographics, behavioral data, other user activity related data such as where and when an item was interacted with and what kind of device was used, and also personal user data such as name and login data.

The basis of all collaborative filtering recommender systems is the above-mentioned client-item matrix R=(rᵢⱼ)∈R^{NxM}. For the sake of simplicity, the description below will at times equate a client i with its user, and an item j with an application available for downloading.

In collaborative filtering, the value rᵢⱼ is derived from explicit feedback such as user reviews, e.g. rᵢⱼ∈(1, . . . , 5).

In the case of implicit feedback such as, e.g., the user downloading an application, rᵢⱼ=1 when user/client i downloaded application/item j, where 1≤i≤N and 1≤j≤M, while rᵢⱼ is unspecified otherwise.

Collaborative filtering is used to replace the unspecified rᵢⱼ with their estimates \hat{r}ᵢⱼ, e.g. by means of Matrix Factorization.

Matrix Factorization involves creating a client factor vector xᵢ∈R^{kx1},

$${x}_{i} = ( \begin{matrix}{x}_{i 1} \\ {x}_{i 2} \\ ⋮ \\ {x}_{i k}\end{matrix} ) ,$$

for each client i, and an item factor vector yⱼ∈R^{kx1},

$${y}_{j} = ( \begin{matrix}{y}_{j 1} \\ {y}_{j 2} \\ ⋮ \\ {y}_{j k}\end{matrix} ) ,$$

for each item j. k is the number of factors, which is typically much lower than both M and N. The estimate for an unspecified rᵢⱼ is then given by [symbol] =xᵢ^{T}yⱼ.

The first model component A is a factor matrix A=X(i,k) comprising a plurality of client factor vectors (xᵢ), and the second model component B is a factor matrix B=Y(j,k) comprising a plurality of item factor vectors (yⱼ).

The client factor vectors are collected into a matrix X∈R^{kxM} where X=(x₁, x₂, . . . , xᵢ, . . . , x_{M}), and the item factor vectors are collected into a matrix Y∈R^{kxN} where Y=(y₁, y₂, . . . , yⱼ, . . . , y_{N}). The client-item matrix R is, in other words, also defined as R=X^{T}Y.

For the case of explicit feedback, a set of binary variables pi are introduced to indicate whether the user/client i has rated an application/item j or not, where

$${p}_{ij} \{ \begin{matrix}1 & {r}_{i j} > 0 \\ 0 & {r}_{i j} = 0\end{matrix} .$$

A value pᵢⱼ>0 means that the application/item j has been rated, while a value pᵢⱼ=0 means that the user has not rated the application/item j or is simply not aware an application/item j exists.

For the case of implicit feedback, a set of binary variables pᵢⱼ are introduced to indicate the preference of user/client i for application/item j, where

$${p}_{ij} \{ \begin{matrix}1 & {r}_{i j} > 0 \\ 0 & {r}_{i j} = 0\end{matrix} .$$

A value pᵢⱼ=0 can have many interpretations including the user/client i not being interested in an application/item j or not being aware an application/item j exists. To account for this, a confidence parameter cᵢⱼ is introduced, defined as cᵢⱼ=1+∝rᵢⱼ where α>0. The implicit feedback problem is, in other words, different from the standard explicit feedback problem in that the confidence levels cᵢⱼ need to be taken into account.

Any updates are to be made across all clients i and all items j rather than just the clients i for which there are downloads j.

In prior art collaborative filtering models, xᵢ is updated by means of the equation xᵢ=(YCⁱY^{T}+λI)⁻¹YCⁱp(i), where Y, Y∈R^{kxN} is the above-mentioned matrix of item factor vectors, Cⁱ is a diagonal matrix with Cⱼⱼⁱ=cᵢⱼ, I is an identity matrix, and p(i)∈R^{Nx1} is a binary preference variable vector for the client i.

Similarly, yⱼ is updated by means of the equation yⱼ=(XC^{j}YX^{T}+λI)⁻¹XC^{j}p(j) where X, X∈R^{kxM}, is the above-mentioned matrix of client factor vectors, Cⁱ is a diagonal matrix with Cᵢᵢ^{j}=cᵢⱼ, and p(i)∈R^{Nx1} is a binary preference variable vector for the client i.

In summary, the above described prior art method uses Y for calculating X, and X for calculating Y, repeating and alternating between the two equations at least until a suitable convergence criteria is met. The convergence criteria is a predefined limit value, for example 1%. C and p, which are based on user/client data, are used for calculating both X and Y, wherefore all user data has to be located in the same place as X and Y, i.e. on the server. This is referred to as the ALS (Alternating Least Squares) method for collaborative filtering, and it is frequently used in prior art.

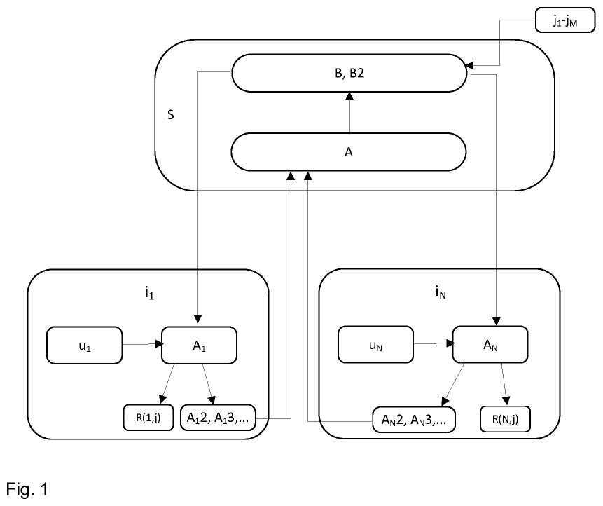

The embodiments of the present disclosure, shown schematically in FIG. 1, comprises an adaptation of the ALS method such that a different approach is taken to calculating Y, which adaptation allows the calculations to be distributed to the client, hence avoiding the need to transfer client data back to the server. All item factor vectors yⱼ∈R^{kx1} are located on the server, updated on the server, and thereafter distributed to each client i. All client factor vectors xᵢ∈R^{kx1} remain on the client i, are updated on the client using local client data uᵢ, and the item factor vectors from the server. The updates, gradients δyᵢⱼ are calculated from item j on each client i and transmitted to the server where they are aggregated and the yⱼ are updated.

All of the values necessary for calculating xᵢ=(YCⁱY^{T}+λI)⁻¹YCⁱp(i) are available on the client i, as long as a current set of item factor vectors yⱼ∈R^{kx1} have been downloaded onto the client i, Y being the matrix of item factor vectors, Cⁱ a diagonal matrix with Cⱼⱼⁱ=cᵢⱼ, λ the regularization factor, I an identity matrix, and p(i)∈R^{Nx1} is a binary preference variable vector for the client i. Furthermore, all of these values are independent from the corresponding values of any other client i. Hence, what corresponds to a first step of the ALS algorithm can be calculated on each individual client i without reference to any other client.

However, when using the ALS method, the calculation of yⱼ, yⱼ=(XC^{j}YX^{T}+λI)⁻¹XC^{j}p(j), requires the matrix of client factor vectors X, wherefore this update must take place on the server where all client data is available. Rather than directly calculating an update of yⱼ, as in the ALS method, the present disclosure applies a gradient descent approach to calculate the updated yⱼ on the server. More specifically, the present disclosure calculates the updated yⱼ, i.e. the updated matrix Y, by means of equation

$${y}_{j} = {y}_{j} - γ \frac{\partial J}{\partial {y}_{j}} ,$$

γ being a gain function and ∂J/∂yⱼ being calculated by means of equation

$$\frac{\partial J}{\partial {y}_{j}} = - 2 {\sum }_{i} [ {c}_{i j} ( {p}_{i j} - {x}_{i}^{T} {y}_{j} ) ] {x}_{i} + 2 λ {y}_{j} .$$

The above-mentioned equation

$$\frac{\partial J}{\partial {y}_{j}}$$

originates from the cost function J, J=ΣᵢΣⱼ cᵢⱼ(pᵢⱼ−xᵢ^{T}yⱼ)²+λ(Σᵢ∥xᵢ∥²+(Σⱼ∥yⱼ∥²), where A is the regularization factor. The cost function J is minimized by alternating the calculations of the client factor vector matrix X and the item factor vector matrix Y. The first step of minimizing the cost function J is to differentiate J with regards to xᵢ for all clients i and yⱼ for all items j, by means of ∂J/∂xᵢ and ∂J/∂yⱼ.

The initial starting value of xᵢ is calculated directly by means of

$$\frac{\partial J}{\partial {x}_{i}} = 0 , {x}_{i} = {( {YC}^{i} {Y}^{T} + λ I )}^{- 1} {YC}^{i} p ( i )$$

as in the ALS method, which is possible since, as mentioned above, the values necessary are available on the client i. ∂J/∂yⱼ, on the other hand, comprises a component which is a summation over all clients i, said summation being defined as f(i,j). f(i,j) is calculated on the client, based only on client data, by means of f(i,j)=[cᵢⱼ(pᵢⱼ−xᵢ^{T}yⱼ)]xᵢ, i.e. f(i,j) is calculated on each client i, independently of all other clients.

Each client i reports back, to the server, an evaluation of the value f(i,j) calculated for each item j, whereafter all of the client evaluations are summarized, on the server, by means of

$$\frac{\partial J}{\partial {y}_{j}} = - 2 {\sum }_{i} f ( i , j ) + 2 λ {y}_{j}$$

and thereafter applied to

$${y}_{j} = {y}_{j} - γ \frac{\partial J}{\partial {y}_{j}} .$$

The present disclosure relates, in other words, to training a collaborative filtering model without having to transfer user data back to the server, and at the same time using the collaborative filtering model to calculate estimates for the unspecified elements of the client-item matrix R. As shown in FIG. 1, the machine learning model component B/ is located on a centralized server S, and a model component Aᵢ is located on a number of determined clients i. The model component B is distributed to each user device/client i, and the initial model component Aᵢ is updated using the model component B and client data uᵢ located on the client i. Updates to be used in model component B, or complete updated model components B, generated on the user device/client i, are transferred back to the server S where they are aggregated across all determined clients i₁-i_{N} to generate a new, updated model component B. The model component Aᵢ stored locally on the client i uses the client data uᵢ for generating the estimates. Hence the client data uᵢ never leaves the client i.

One aspect of the present disclosure relates to a client I adapted for updating individual elements rᵢⱼ of a client-item matrix R by means of collaborative filtering, see FIG. 1. The client-item matrix R, R=(rᵢⱼ)∈R^{NxM}, comprises a plurality of individual elements rᵢⱼ, each individual element relating to a specific client i and a specific item j. By specific is meant one single client i or item j.

The client i utilizes, as shown in FIG. 1, an individual part Aᵢ of a first model component A and at least one element of local client data uᵢ, the first model component A being a factor matrix A=X(i,k) comprising a plurality of client factor vectors xᵢ,

$${x}_{i} = ( \begin{matrix}{x}_{i 1} \\ {x}_{i 2} \\ ⋮ \\ {x}_{i k}\end{matrix} ) ,$$

k being the number of factors. The individual part Aᵢ of the first model component A is the client factor vector xᵢ for the client i.

The client i is, furthermore, connected to a server S utilizing a second model component B and a global set of items j₁, . . . , j_{M}, as shown in FIG. 1, M being the maximum number of items.

The second model component B is a factor matrix B=Y(j,k) comprising a plurality of item factor vectors yⱼ,

$${y}_{j} = ( \begin{matrix}{y}_{j 1} \\ {y}_{j 2} \\ ⋮ \\ {y}_{j k}\end{matrix} ) .$$

The client i is configured to execute the following steps, shown schematically in FIG. 1:
A. assign the individual part Aᵢ of the first model component A to the client (i),
B. download the second model component B from the server,
C. calculate an updated individual part Aᵢ2 of the first model component A by means of the downloaded second model component B and the element of local client data uᵢ,
D. calculate an individual value for each item j₁, . . . , j_{M} by means of a function f(i,j), the function using the downloaded second model component B, the updated individual part Aᵢ2 of the first model component A, and the element of local client data uᵢ,
E. upload an evaluation of the value to the server such that an updated second model component B2 is calculated by the server by means of the second model component B and an aggregate of evaluations of the value uploaded from a plurality of clients i₁, . . . , i_{N} including the client and other determined clients, N being a maximum number of clients,
F. download the updated second model component B2 from the server,
G. calculate a new updated individual part Aᵢ3 of the first model component A by means of the updated second model component B2 and the element of local client data uᵢ, and
H. update at least one individual element rᵢⱼ of the matrix R by means of the new updated individual part Aᵢ3 of the first model component A and the updated second model component B2.

At least one individual element rᵢⱼ of the client-item matrix R is unspecified, and the above-mentioned updating of individual elements rᵢⱼ, mentioned in step H above, comprises replacing such unspecified individual elements rᵢⱼ with their estimates (\hat{r}ᵢⱼ), \hat{r}ᵢⱼ=xᵢ^{T}yⱼ.

The client-item matrix R is used for generating personalized application recommendations for a user of the client i, the recommendations, relating to at least one of the items j₁, . . . , j_{M}, are generated on the client i by means of the individual elements \hat{r}ᵢⱼ, rᵢⱼ.

The step of assigning an individual part Aᵢ of the first model component A may comprise selecting an individual part Aᵢ of a random model component A or an individual part A of a previously known model component A.

The above-mentioned steps C-H may be repeated at least until a predefined convergence threshold has been reached for the first model component A and/or the second model component B.

The aggregate of evaluations, mentioned in step E above, may be calculated by means of equation

$$\frac{\partial J}{\partial {y}_{j}} = - 2 {\sum }_{i} f ( i , j ) + 2 λ {y}_{j} ,$$

wherein λ is a regularization parameter and J is a cost function.

The second model component B may be updated, as mentioned in step E above. The updating is executed by means of equation

$${y}_{j} = {y}_{j} - γ \frac{\partial J}{\partial {y}_{j}} ,$$

wherein γ is a gain function.

The element of local client data uᵢ may comprise explicit user feedback relating to one of the items j₁, . . . , j_{M}, in which case the function f(i,j), mentioned in step D above, may be calculated by means of equation f(i,j)=[pᵢⱼ(rᵢⱼ−xᵢ^{T}yⱼ)]xᵢ, wherein p is a binary preference variable which indicates the preference of the user of a client i for an item j₁, . . . , j_{M}, by means of

$${p}_{ij} \{ \begin{matrix}1 & {r}_{i j} > 0 \\ 0 & {r}_{i j} = 0\end{matrix} ,$$

a value pᵢⱼ=1 indicating an interest in item j₁, . . . , j_{M}, and a value pᵢⱼ=0 indicating one of a disinterest in item j₁, . . . , j_{M} or unawareness of the item. The first model component A may, in this case, be updated as mentioned in steps C and G above. The updating is executed by means of equation xᵢ=(Yₚ(i)Y^{T}+λI)⁻¹YRⁱp(i), wherein p(i) is a binary preference variable vector for the client i, Rⁱ is a vector of known inputs for client i, I is an identity matrix, and λ is a regularization parameter.

The element of local client data uᵢ may also comprise implicit user feedback relating to one of the items j₁, . . . , j_{M}, in which case the function f(i,j), mentioned in step D above, is calculated by means of equation f(i,j)=[cᵢⱼ(pᵢⱼ−xᵢ^{T}yⱼ)]xᵢ, wherein c is a confidence parameter and p is a binary preference variable which indicates the preference of a user of a client (i) for an item (j₁, . . . , j_{M}), by means of

$${p}_{ij} \{ \begin{matrix}1 & {r}_{i j} > 0 \\ 0 & {r}_{i j} = 0\end{matrix} ,$$

a value pᵢⱼ=1 indicating an interest in item (j₁, . . . , j_{M}), and a value pᵢⱼ=0 indicating one of a disinterest in item j₁, . . . , j_{M} or unawareness of the item. The first model component (A) may, in this case, be updated by means of equation xᵢ=(YCⁱY^{T}+λI)⁻¹YCⁱp(i), wherein p(i) is a binary preference variable vector for the client i, Cⁱ is a diagonal matrix, I is an identity matrix, and λ is a regularization parameter.

A further aspect of the present disclosure relates to a server S adapted for updating individual elements rᵢⱼ of the above-mentioned client-item matrix R by means of collaborative filtering. The client-item matrix R, R=(rᵢⱼ)∈R^{NxM}, comprises a plurality of individual elements rᵢⱼ, each individual element relating to a specific client i and a specific item j. By specific is meant one single client i or item j.

As shown in FIG. 1, the server S utilizes a second model component B and a global set of items j₁, . . . , j_{M}, the second model component B being a factor matrix B=Y(j,k) comprising a plurality of item factor vectors yⱼ,

$${y}_{j} = ( \begin{matrix}{y}_{j 1} \\ {y}_{j 2} \\ ⋮ \\ {y}_{j k}\end{matrix} ) ,$$

k being the number of factors.

The server S is, furthermore, connected to a plurality of clients i₁, . . . , i_{N} utilizing a first model component A. Each individual client i comprises an individual part A of the complete first model component A, and each individual client i utilizes at least one element of local client data uᵢ see FIG. 1. The first model component A is a factor matrix A=X(i,k) comprising a plurality of client factor vectors xᵢ,

$${x}_{i} = ( \begin{matrix}{x}_{i 1} \\ {x}_{i 2} \\ ⋮ \\ {x}_{i k}\end{matrix} ) ,$$

k being the number of factors. The individual part Aᵢ of the first model component A is the client factor vector xᵢ for the client i.

The server is configured to execute the following steps, shown schematically in FIG. 1:
A. determine several of the clients i, . . . , i_{N}, which in one embodiment comprises determining all available clients i,
B. assign a second model component B to the server,
C. receive an aggregate of evaluations of individual values from the several determined clients i₁, . . . , i_{N}, in each determined client i an updated individual part Aᵢ2 of the first model component A is calculated by means of the assigned second model component B which is downloaded by each determined client i and the element of local client data uᵢ, and the individual value for each item j₁, . . . , j_{M} is calculated by means of a function f(i,j), the function using the assigned second model component B, the updated individual part Aᵢ2 of the first model component A, and the element of local client data uᵢ, and the evaluation of the value is uploaded by each determined client i to the server,
D. calculate an updated second model component B2 by means of the assigned second model component B and the aggregate of evaluations uploaded from the several determined clients i₁, . . . , i_{N}, and
E. transmit the updated second model component B2 to each determined client i such that, in each determined client i, a new updated individual part (Aᵢ3) of the first model component (A) is calculated by means of the updated second model component (B2) and the element of local client data uᵢ, and at least one individual element rᵢⱼ of the matrix (R) is updated, on the determined client i, by means of the new updated individual part Aᵢ3 of the first model component A and the updated second model component B2.

At least one individual element rᵢⱼ of the client-item matrix R is unspecified, and the above-mentioned updating of individual elements rᵢⱼ, on the determined client, comprises replacing such unspecified individual elements rᵢⱼ with their estimates (\hat{r}ᵢⱼ), \hat{r}ᵢⱼ=xᵢ^{T}yⱼ.

The client-item matrix R is used for generating personalized application recommendations for the user of the client i, the recommendations, relating to at least one of the items j₁, . . . , j_{M}, are generated on the client i by means of the individual elements \hat{r}ᵢⱼ, rᵢⱼ.

The aggregate of evaluations may be calculated by means of equation,

$$\frac{\partial J}{\partial {y}_{j}} = - 2 {\sum }_{i} f ( i , j ) + 2 λ {y}_{j} ,$$

wherein λ is a regularization parameter and J is a cost function.

The second model component B may be updated as mentioned in step D above. The updating is executed by means of equation

$${y}_{j} = {y}_{j} - γ \frac{\partial J}{\partial {y}_{j}} ,$$

wherein γ is a gain function.

The element of local client data uᵢ may comprise explicit user feedback relating to one of the items j₁, . . . , j_{M}, in which case the function f(i,j) may be calculated by means of equation f(i,j)=[pᵢⱼ(rᵢⱼ−xᵢ^{T}yⱼ)]xᵢ, wherein p is a binary preference variable which indicates the preference of the user of a client i for an item j₁, . . . , j_{M}, by means of

$${p}_{ij} \{ \begin{matrix}1 & {r}_{ij} > 0 \\ 0 & {r}_{ij} = 0\end{matrix} ,$$

a value pᵢⱼ=1 indicating an interest in item j₁, . . . , j_{M}, and a value pᵢⱼ=0 indicating one of a disinterest in item j₁, . . . , j_{M} or unawareness of the item. The first model component A may, in this case, be updated by means of equation xᵢ=(Yp(i)Y^{T}+λI)⁻¹YRⁱp(i), wherein p(i) is a binary preference variable vector for the client i, Rⁱ is a vector of known inputs for client i, I is an identity matrix, and λ is a regularization parameter.

The element of local client data uᵢ may also comprise implicit user feedback relating to one of the items j₁, . . . , j_{M}, in which case the function f(i,j) is calculated by means of equation f(i,j)=[cᵢⱼ(pᵢⱼ−xᵢ^{T}yⱼ)]xᵢ, wherein c is a confidence parameter and p is a binary preference variable which indicates the preference of a user of a client (i) for an item (j₁, . . . , j_{M}), by means of

$${p}_{ij} \{ \begin{matrix}1 & {r}_{ij} > 0 \\ 0 & {r}_{ij} = 0\end{matrix} ,$$

a value pᵢⱼ=1 indicating an interest in item (j₁, . . . , j_{M}), and a value pᵢⱼ=0 indicating one of a disinterest in item j₁, . . . , j_{M} or unawareness of the item. The first model component (A) may, in this case, be updated by means of equation xᵢ=(YCⁱY^{T}+λI)⁻¹YCⁱp(i), wherein p(i) is a binary preference variable vector for the client i, Cⁱ is a diagonal matrix, I is an identity matrix, and λ is a regularization parameter.

Yet another aspect of the present disclosure relates to a client-server system adapted for updating individual elements rᵢⱼ of the above-mentioned client-item matrix R by means of collaborative filtering. The system comprises the above-mentioned server and a plurality of the above-mentioned client.

FIG. 1 shows the flow of information in a client-server system adapted for updating a client-item matrix R schematically. Value f(i,j), for item j, is calculated on the client i using local user data uᵢ. The values f(i,j) for a plurality of items j are transmitted back to the server S, from a plurality of clients, and aggregated, whereafter model component B is updated. Hence, no local client data uᵢ need be transferred out of the client i to update model component A. Each model component Aᵢ is also updated on the user device/client.

The system comprises one server S and a N number of clients i. For the sake of simplicity, FIG. 1 shows only two clients, i₁ and i_{N}, i.e. i_{N} equals i₂. Client i₁ utilizes local client data uᵢ, i.e. uᵢ₁, as well as an individual part Aᵢ, i.e. Aᵢ₁, of a first model component A. Similarly, client i₂ utilizes local client data uᵢ, i.e. uᵢ₂, as well as an individual part Aᵢ, i.e. Aᵢ₂, of a first model component A. The server S utilizes a second model component B as well as a global set of items j. The client-item matrix R is updated to provide one or several estimates for unspecified elements of the client-item matrix R.

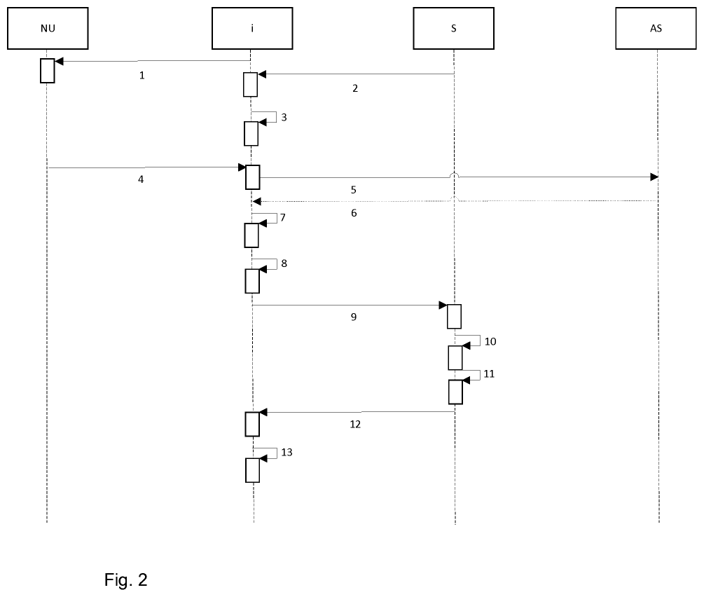

FIG. 2 shows one example of the steps taken when a new user NU is identified and attempts to download an item j, i.e. application, from an app service AS to a client i. The corresponding steps could be taken, e.g., when the user of the client downloads a video from a video service, or purchases a physical item from an online shop.

The steps shown in FIG. 2 comprise the following:

Step 1: The user NU browses the app store AS and the client i₁ shows top list recommendations, comprising one or several applications j, to the user NU.

Step 2: Model component B is transferred from the server S to the client i₁. This corresponds to step B, executed by the client, above.

Step 3: The client i₁ is assigned a random individual part Aᵢ of model component A. This corresponds to step A, executed by the client, above.

Step 4: The user NU submits a request for an application j₁ to be downloaded on the client i₁.

Step 5: The request is transmitted from the client i₁ to the app service AS.

Step 6: The application j is downloaded to the client ii from the app service AS.

Step 7: The individual part Aᵢ of model component A is updated on the client i₁, forming updated individual part Aᵢ2. This corresponds to step C, executed by the client, above.

Step 8: An update of model component B is generated on the client i₁. This corresponds to step D, executed by the client, above.

Step 9: The update of model component B is transferred from the client i₁ to the server S. This corresponds to step E, executed by the client, above.

Step 10: The server S aggregates model component B updates from several clients i₁, . . . , i_{N}. This corresponds to a part of step D, executed by the server, above.

Step 11: The model component B is updated on the server S. This corresponds to a part of step D, executed by the server, above.

Step 12: An updated model component B2 is downloaded from the server S to all clients i₁, . . . , i_{N}. This corresponds to step F, executed by the client, above.

Step 13: The individual part Aᵢ2 of model component A is updated on the client ii, forming new, updated individual part Aᵢ3. This corresponds to step G, executed by the client, above.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope.

1. A client adapted for updating individual elements (rij) of a client-item matrix (R) by means of collaborative filtering, R=X^{T}Y, rᵢⱼ=xᵢ^{T}yⱼ, T being a matrix/vector transpose,
said matrix (R) comprising a plurality of individual elements (rij), each individual element relating to a specific client (i) and a specific item (j),
said client utilizing an individual part (Ai) of a first model component (A) and at least one element of local client data (ui),
said first model component (A) being a factor matrix A=X(i,k) comprising a plurality of client factor vectors (xᵢ),
$${x}_{i} = ( \begin{matrix}{x}_{i 1} \\ {x}_{i 2} \\ ⋮ \\ {x}_{ik}\end{matrix} ) ,$$
k being the number of factors,
said individual part (Ai) of said first model component (A) being the client factor vector (xᵢ) for said client,
said client being connected to a server utilizing a second model component (B) and a global set of items (j₁, . . . , j_{M}), M being a maximum number of items,
said second model component (B) being a factor matrix B=Y(j,k) comprising a plurality of item factor vectors (yⱼ),
$${y}_{j} = ( \begin{matrix}{y}_{j 1} \\ {y}_{j 2} \\ ⋮ \\ {y}_{jk}\end{matrix} ) ,$$
k being the number of factors,
said client being configured to:
A. assign said individual part (Aᵢ) of said first model component (A) to said client,
B. download a second model component (B) from said server,
C. calculate an updated individual part (Aᵢ2) of said first model component (A) by means of said downloaded second model component (B) and said element of local client data (uᵢ),
D. calculate an individual value for each item (j₁, . . . , j_{M}) by
means of a function f(i,j), said function using said downloaded second model component (B), said updated individual part (Aᵢ2) of said first model component (A), and said element of local client data (uᵢ),
E. upload an evaluation of said value to said server such that an updated second model component (B2) is calculated by said server by means of said second model component (B) and an aggregate of evaluations of said value uploaded from a plurality of clients (i₁, . . . , i_{N}) including said client and other determined clients, N being a maximum number of clients,
F. download said updated second model component (B2) from said server,
G. calculate a new updated individual part (Aᵢ3) of said first model component (A) by means of said updated second model component (B2) and said element of local client data (uᵢ),
H. update at least one individual element (rᵢⱼ) of said matrix (R) by means of said new updated individual part (Aᵢ3) of said first model component (A) and said updated second model component (B2).

2. The client according to claim 1, wherein at least one individual element (rᵢⱼ) of said client-item matrix (R) is unspecified, and wherein said updating of individual elements (rᵢⱼ) comprises replacing an unspecified individual element (rᵢⱼ) with an estimate (\hat{r}ᵢⱼ), \hat{r}ᵢⱼ=xᵢ^{T}yⱼ.

3. The client according to claim 2, wherein said client-item matrix (R) is used for generating personalized application recommendations for a user of said client, said recommendations, relating to at least one of said items (j₁, . . . , j_{M}), being generated on said client by means of said individual elements (\hat{r}ᵢⱼj, rᵢⱼ).

4. The client according to claim 1, wherein said aggregate of evaluations is calculated by means of equation
$$\frac{\partial J}{\partial {y}_{j}} = - 2 {\sum }_{i}^{ } f ( i , j ) + 2 λ {y}_{j} ,$$
wherein λ is a regularization parameter and J is a cost function.

5. The client according to claim 4, wherein said second model component (B) is updated by means of equation
$${y}_{j} = {y}_{j} - γ \frac{\partial J}{\partial {y}_{j}} ,$$
wherein γ is a gain function.

6. The client according to claim 1, wherein said function f(i,j) is calculated by means of equation f(i,j)=[pᵢⱼ(rᵢⱼ−xᵢ^{T}yⱼ)]xᵢ, wherein p is a binary preference variable which indicates the preference of a user of a client for an item (j₁, . . . , j_{M}), by means of
$${p}_{ij} \{ \begin{matrix}1 & {r}_{ij} > 0 \\ 0 & {r}_{ij} = 0\end{matrix} ,$$
a value pᵢⱼ=1 indicating an interest in item (j₁, . . . , j_{M}), and a value pᵢⱼ=0 indicating one of a disinterest in item (j₁, . . . , j_{M}) or unawareness of said item.

7. The client according to claim 1, wherein said first model component (A) is updated by means of equation xᵢ=(Yp(i)Y^{T}+λI)⁻¹YRⁱp(i), wherein p(i) is a binary preference variable vector for said client, Rⁱ is a vector of known inputs for client, I is an identity matrix, and λ is a regularization parameter.

8. The client according to claim 1, wherein said element of local client data (uᵢ) comprises implicit user feedback relating to one of said items (j₁, . . . , j_{M}).

9. The client according to claim 8, wherein said function f(i,j) is calculated by means of equation f(i,j)=[cᵢⱼ(pᵢⱼ−xᵢ^{T}yⱼ)]xᵢ, wherein c is a confidence parameter and p is a binary preference variable which indicates the preference of a user of a client for an item (j₁, . . . , j_{M}), by means of
$${p}_{ij} \{ \begin{matrix}1 & {r}_{ij} > 0 \\ 0 & {r}_{ij} = 0\end{matrix} ,$$
a value pᵢⱼ=1 indicating an interest in item (j₁, . . . , j_{M}), and a value pᵢⱼ=0 indicating one of a disinterest in item (j₁, . . . , j_{M}) or unawareness of said item.

10. The client according to claim 8, wherein said first model component (A) is updated by means of equation xᵢ=(YCⁱY^{T}+λI)⁻¹YCⁱp(i), wherein p(i) is a binary preference variable vector for said client, Cⁱ is a diagonal matrix, and λ is a regularization parameter.

11. A server adapted for updating individual elements (rᵢⱼ) of a client-item matrix R by means of collaborative filtering, R=X^{T}Y, rᵢⱼ=xᵢ^{T}yⱼ, T being a matrix/vector transpose,
said matrix (R) comprising a plurality of individual elements (rᵢⱼ), each individual element relating to a specific client (i) and a specific item (j),
said server utilizing a second model component (B) and a global set of items (j₁, . . . , j_{M}), M being a maximum number of items,
said second model component (B) being a factor matrix B=Y(j,k) comprising a plurality of item factor vectors (yⱼ),
$${y}_{j} = ( \begin{matrix}{y}_{j 1} \\ {y}_{j 2} \\ ⋮ \\ {y}_{jk}\end{matrix} ) ,$$
k being the number of factors,
said server being connected to a plurality of clients (i₁, . . . , i_{N}) utilizing a first model component (A), N being a maximum number of clients, each individual client comprising an individual part (Aᵢ) of said first model component (A), and each individual client further utilizing at least one element of local client data (uᵢ), said first model component (A) being a factor matrix A=X(i,k) comprising a plurality of client factor vectors (xᵢ),
$${x}_{i} = ( \begin{matrix}{x}_{i 1} \\ {x}_{i 2} \\ ⋮ \\ {x}_{ik}\end{matrix} ) ,$$
k being the number of factors,
said individual part (Aᵢ) of said first model component (A) being the client factor vector (xᵢ) for said client,
said server being configured to:
A. determine several of said clients (i₁, . . . , i_{N}),
B. assign a second model component (B) to said server,
C. receive an aggregate of evaluations of individual values from the several determined clients (i₁, . . . , i_{N}), wherein in each determined client an updated individual part (Ai2) of said first model component (A) is calculated by means of said assigned second model component (B) which is downloaded by each determined client and said element of local client data (uᵢ), and said individual value for each item (j₁, . . . , j_{M}) is calculated by means of a function f(i,j), said function using said assigned second model component (B), said updated individual part (Ai2) of said first model component (A), and said element of local client data (uᵢ), and said evaluation of said value is uploaded by each determined client to said server,
D. calculate an updated second model component (B2) by means of said assigned second model component (B) and said aggregate of evaluations uploaded from the several determined clients (i₁, . . . i_{N}),
E. transmit said updated second model component (B2) to each determined client such that, in each determined client, a new updated individual part (Aᵢ3) of said first model component (A) is calculated by means of said updated second model component (B2) and said element of local client data (uᵢ), and at least one individual element (rᵢⱼ) of said matrix (R) is updated, on said determined client, by means of said new updated individual part (Aᵢ3) of said first model component (A) and said updated second model component (B2).

12. The server according to claim 11, wherein at least one individual element (rᵢⱼ) of said client-item matrix (R) is unspecified, and wherein said updating of individual elements (rᵢⱼ), on said determined client, comprises replacing an unspecified individual element (rᵢⱼ) with an estimate (\hat{r}ᵢⱼ), \hat{r}ᵢⱼ=xᵢ^{T}yⱼ.

13. The server according to claim 11, wherein said client-item matrix (R) is used for generating personalized application recommendations for a user of said client, said recommendations, relating to at least one of said items (j₁, . . . , j_{M}), being generated on said client by means of said individual elements (\hat{r}ᵢⱼ, rᵢⱼ).

14. The server according to claim 11, wherein said aggregate of evaluations is calculated by means of equation
$$\frac{\partial J}{\partial {y}_{j}} = - 2 {\sum }_{i}^{ } f ( i , j ) + 2 λ {y}_{j} ,$$
wherein λ is a regularization parameter and J is a cost function.

15. The server according to claim 14, wherein said second model component (B) is updated by means of equation
$${y}_{j} = {y}_{j} - γ \frac{\partial J}{\partial {y}_{j}} ,$$
wherein γ is a gain function.

16. The server according to claim 11, wherein said function f(i,j) is calculated by means of equation f(i,j)=[pᵢⱼ(rᵢⱼ−xᵢ^{T}yⱼ)]xᵢ, wherein p is a binary preference variable which indicates the preference of a user of a client for an item (j₁, . . . , j_{M}), by means of
$${p}_{ij} \{ \begin{matrix}1 & {r}_{ij} > 0 \\ 0 & {r}_{ij} = 0\end{matrix} ,$$
a value pᵢⱼ=1 indicating an interest in item (j₁, . . . , j_{M}), and a value pᵢⱼ=0 indicating one of a disinterest in item (j₁, . . . , j_{M}) or unawareness of said item.

17. The server according to claim 11, wherein said first model component (A) is updated by means of equation xᵢ=(Yp(i)Y^{T}+λI)⁻¹YRⁱp(i), wherein p(i) is a binary preference variable vector for said client, Rⁱ is a vector of known inputs for client, I is an identity matrix, and λ is a regularization parameter.

18. The server according to claim 11, wherein said element of local client data (uᵢ) comprises implicit user feedback relating to one of said items (j₁, . . . , j_{M}).

19. The server according to claim 18, wherein said function f(i,j) is calculated by means of equation f(i,j)=[cᵢⱼ(pᵢⱼ−xᵢ^{T}yⱼ)]xᵢ, wherein c is a confidence parameter and p is a binary preference variable which indicates the preference of a user of a client for an item (j₁, . . . , j_{M}), by means of
$${p}_{ij} \{ \begin{matrix}1 & {r}_{ij} > 0 \\ 0 & {r}_{ij} = 0\end{matrix} ,$$
a value pᵢⱼ=1 indicating an interest in item (j₁, . . . , j_{M}), and a value pᵢⱼ=0 indicating one of a disinterest in item (j₁, . . . , j_{M}) or unawareness of said item.

20. The server according to claim 18, wherein said first model component (A) is updated by means of equation xᵢ=(YCⁱY^{T}+λI)⁻¹YCⁱp(i), wherein p(i) is a binary preference variable vector for said client, Cⁱ is a diagonal matrix, I is an identity matrix, and λ is a regularization parameter.

21. (canceled)
